(19) United States
(12) Patent Application Publication
(10) Pub. No.: US 2017/0159273 A1
(43) Pub. Date: Jun. 8, 2017

(54) SHOWER HEAD ASSEMBLY

(71) Applicants: Ronnie Emery, Oklahoma City, OK (US); Clotia Emery, Oklahoma City, OK (US)

(72) Inventors: Ronnie Emery, Oklahoma City, OK (US); Clotia Emery, Oklahoma City, OK (US)

(21) Appl. No.: 14/959,211

(22) Filed: Dec. 4, 2015

(51) Int. Cl. E03C 1/046; B05B 1/18; B05B 7/30; B05B 1/30

(52) U.S. Cl. CPC E03C 1/046; B05B 1/3026; B05B 1/18; B05B 7/30

(57) ABSTRACT

A shower head assembly for cleaning fluid integration that includes: a shower head, where the shower head is attachable to a water pipe; a connector at a connection end of the shower head, where the connector connects the shower head to a water pipe; a first nozzle extending from a first side of a connector attached to the end of the shower head; a first tube extending from the first nozzle into a bottom of a first canister; a second nozzle extending from a second side of a connector attached to the end of the shower head; and a second tube extending from the second nozzle into a bottom of a second canister, wherein in the first canister and second canister includes a cleaning fluid and said cleaning fluid flows through each respective tube into water flow through the connector. The first nozzle enables release of cleaning fluid from the first canister to the first tube and the second nozzle enables release of cleaning fluid from the second canister to the second tube. In one particular embodiment, the first canister includes a body wash and the second canister includes a shampoo.

### BACKGROUND OF THE INVENTION

Field of Invention

The present invention relates to a showerhead assembly that includes attachments of cleaning fluids through the water flow system.

Description of Related Art

Showers are a common personal-hygiene activity as a means to clean and wash both body and hair. Typically a user has a shower head that provides a stream of water over the user's body and head. Soap and shampoo are typically used by the user within the shower stall in some form of liquid or bar soap with liquid shampoo in a container. One particular drawback to showering is obtaining the soap or shampoo while in the shower. Although showers normally have a placement means for the soap and/or shampoo, sometimes these items may be slippery and cause difficulty for the user over time. As a result, it would be advantageous to have a system where body wash and shampoo are fed through the waterflow system of the showerhead. Such a system would alleviate the need for and eliminate problems with obtaining and maintaining control of the soap and shampoo while in the shower.

### SUMMARY OF THE INVENTION

The present invention relates to a shower head assembly for cleaning fluid integration that includes: a shower head, where the shower head is attachable to a water pipe; a connector at a connection end of the shower head, where the connector connects the shower head to a water pipe; a first nozzle extending from a first side of a connector attached to the end of the shower head; a first tube extending from the first nozzle into a bottom of a first canister; a second nozzle extending from a second side of a connector attached to the end of the shower head; and a second tube extending from the second nozzle into a bottom of a second canister, wherein in the first canister and second canister includes a cleaning fluid and said cleaning fluid flows through each respective tube into water flow through the connector. The first nozzle enables release of cleaning fluid from the first canister to the first tube and the second nozzle enables release of cleaning fluid from the second canister to the second tube. In one particular embodiment, the first canister includes a body wash and the second canister includes a shampoo.

### BRIEF DESCRIPTION OF DRAWINGS

FIG. 1 depicts a front view of a showerhead assembly in accordance with the present invention.

FIG. 2 depicts a side view of the showerhead assembly in accordance with the present invention.

### DETAILED DESCRIPTION

The present invention relates to a showerhead assembly that connects to a conventional showerhead pipe, where the assembly includes canisters fed into the shower head which release shampoo or body wash directly through the water flow that feeds into a dispensing shower head. The showerhead assembly according to the present invention has a canister for body wash on a first side and a canister for shampoo on a second side, each with release nozzles that release the flow of the shampoo or body wash directly into the waterflow of the shower head. As a result, the user receives the soapy body wash or shampoo without the need to locate a separate container or even handle a separate container to receive a flow of cleansing fluid. Each canister is refillable and capable of receiving additional fluids for dispensing through the shower head.

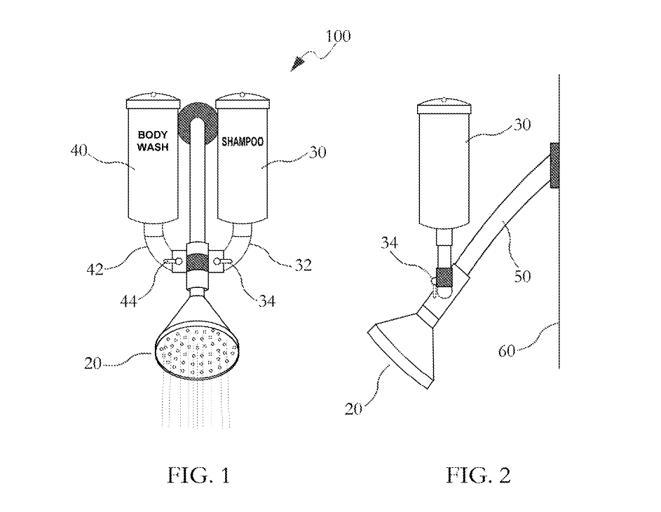

In reference to FIG. 1, a front view of the Showerhead Assembly 100 is depicted. The Showerhead Assembly 100 includes a Shower Head 20 that attaches to a Water Pipe 50 as shown in FIG. 2. Shower Head 20 also receives flow tubes from each respective canister as shown in FIG. 1. Flow Tube 42 provides a flow of body wash from Canister 40 as shown in FIG. 1. The body wash from the Canister 40 feeds into a Nozzle Release 44 that enables a user to release the body wash contained within the Canister 40 into the flow of water through the Shower Head 20. Reciprocally on the opposing side of the Shower Head 20 is a Canister 30 that feeds through Flow Tube 32. A Nozzle Release 34 is provided to allow for the flow of shampoo through Shower Head 20 as shown in FIG. 1. As a result, a user may easily release body wash or shampoo if desired into the Shower Head 20. The Flow Tube 32 and Flow Tube 42 connect to a connector extending from the end of the Shower Head 20. The Tubes 32, 42 therefore flow into the water flow from Pipe 50.

FIG. 2 depicts a side view of the Showerhead Assembly 100 showing Canister 30 feeding into one side of the Shower Head 20. A clear view of the Water Pipe 50 extending from a Shower Wall 60 is shown in FIG. 2. The Water Pipe 50 provides a flow of water into the Shower Head 20, which receives an additional flow of either a shampoo or body wash from either Canister 30 or Canister 40 of the present invention. As a result, a user may easily dispense cleaning fluids as desired through either canister directly through the showerhead provided. The instant invention has been shown and described in what it considers to be the most practical and preferred embodiments. It is recognized, however, that departures may be made there from within the scope of the invention and that obvious modifications will occur to a person skilled in the art.

1. A shower head assembly for cleaning fluid integration comprising:
a) a shower head, where the shower head is attachable to a water pipe;
b) a connector at a connection end of the shower head, where the connector connects the shower head to a water pipe;
c) a first nozzle extending from a first side of a connector attached to the end of the shower head;
d) a first tube extending from the first nozzle into a bottom of a first canister, wherein the first tube is adapted to allow a gravitational flow of a cleaning fluid from the first canister;
e) a second nozzle extending from a second side of a connector attached to the end of the shower head; and
f) a second tube extending from the second nozzle into a bottom of a second canister, wherein the second tube is adapted to allow a gravitational flow of a cleaning fluid from the second canister, and said cleaning fluid is adapted to flows through each respective tube into water flow through the connector.

2. The shower head assembly according to claim 1, where the first nozzle enables release of cleaning fluid from the first canister to the first tube and the second nozzle enables release of cleaning fluid from the second canister to the second tube.

3. The shower head assembly according to claim 2, where first canister includes a body wash and the second canister includes a shampoo.
